(19) United States
(12) Patent Application Publication
(10) Pub. No.: US 2005/0115175 A1
(43) Pub. Date: Jun. 2, 2005

(54) Construction compositions and methods

(76) Inventor: Dallas R. Stovall, Madras, OR (US)

Correspondence Address: KOLISCH HARTWELL, P.C., 520 S.W. YAMHILL STREET, SUITE 200, PORTLAND, OR, 97204, US

(21) Appl. No.: 10/958,672

(22) Filed: Oct. 4, 2004

Related U.S. Application Data
(60) Provisional application No. 60/508,561, filed on Oct. 6, 2003.

(51) Int. Cl. E06B 3/00

(52) U.S. Cl. 52/204.5

(57) ABSTRACT

Various wood composite designs are disclosed for use in door and window systems, incorporating strengthening sheets to inhibit bowing or cupping.

### CROSS REFERENCE TO RELATED APPLICATION

This application claims priority under 35 U.S.C. § 119 and applicable foreign and international law of U.S. Provisional Patent Application Ser. No. 60/508,561 filed Oct. 3, 2003 and is hereby incorporated by reference in its entirety for all purposes.

### FIELD OF THE INVENTION

The invention relates to compositions and methods of constructing door and window systems involving techniques for resisting bowing or warping affects.

### BACKGROUND OF THE INVENTION

Efficient manufacturing of high performance stable wood components has become an important focus of product design in the fenestration industry. Performance standards require that wood components remain straight over time. Another important objective is to reduce the amount of costly appearance grade wood that is used in windows and doors while still maintaining the strength needed for long-term reliably functioning products. Market-driven demands due to increasing product liability along with more stringent building code requirements are making these two issues top priorities in the industry. One approach to containing cost of materials is to use laminated wood components including higher grades of wood for appearance glued to lower grades of wood, such as plywood, or finger-jointed short pieces of scrap wood to give the appearance of solid wood.

However, engineered wood composite products are often susceptible to bowing, twisting, crooking or cupping (collectively referred to as “warping” affects). In each instance, a component of the composite tends to deviate from linear or straight orientation, possibly causing compromised mechanical function of a window or door, unwanted gaps around a closed door or window, etc. and other significant problems.

A primary cause for engineered wood composite materials to move out of parallel occurs when two pieces of material having different moisture contents are glued together. Maintaining equal moisture content between boards or laminated components is difficult on a mass production basis. Wood, by nature, tends to shrink when you remove moisture and it expands when it absorbs moisture. After laminating wood components together, the differing moisture contents of each component may eventually equalize to the same moisture content over time. The component that had the most moisture originally may shrink more than the other component. This difference in shrinking between components pulls on one piece relative to the other, and causes some degree of movement out of parallel, often resulting in compromised function or appearance.

Movement out of parallel may also happen with non-engineered wood components. This movement may be caused by poor kiln drying practices, or because of different densities within the tree based on growing patterns, or stresses on the tree due to wind and other climatic conditions.

Another cause of moisture-induced movement in fenestration products may occur after installation. A door or window system may be installed with one surface exposed to an interior climate, and the other surface exposed to an exterior climate. In this instance, moisture, and temperatures may be quite different between the inside and outside resulting in unbalanced or erratic moisture migration causing bowing or warpage of wood components.

One approach to maintaining wood components straight, or at least resisting bowing to some extent, is to control moisture migration by applying moisture barriers on various surfaces around a door or window system. However, this approach is inadequate for many door and window systems because unprotected, or unsealed surfaces may still permit moisture migration resulting in warping.

### SUMMARY

Wood components are bonded together to form door or window systems including one or more strengthening sheets at selected locations to resist warping affects.

### BRIEF DESCRIPTION OF THE FIGURES

FIG. 1A is a cross-section of a wood composite member for a door or window system.

FIG. 1B is a perspective view of the composite shown in FIG. 1A.

FIG. 1C is a partial perspective view of the wood composite member shown in FIGS. 1A and 1B, indicating an additional processing profile.

FIG. 2A is a cross-section of another wood composite member for a door or window system.

FIG. 2B is a partial perspective view of the composite member shown in FIG. 2A, indicating an additional processing profile.

FIG. 3A is another cross-sectional view of a wood composite member for a door or window system.

FIG. 3B is a partial perspective view of the composite member shown in FIG. 3A, indicating an additional processing profile.

FIG. 4A is another cross-sectional view of a wood composite member for a door or window system.

FIG. 4B is a partial cross-sectional view of a door jamb incorporating the composite member shown in FIG. 4A, with additional components.

FIG. 5A is another cross-sectional view of a wood composite member for a door or window system.

FIG. 5B is a partial cross-sectional view of a door jamb incorporating the composite member shown in FIG. 5A, with additional components.

FIG. 6A is another cross-sectional view of a wood composite member for a door or window system.

FIG. 6B is a partial cross-sectional view of a door jamb incorporating the composite member shown in FIG. 6A, with additional components.

FIG. 7 is a cross-sectional view of another wood composite member for a door or window system.

### DESCRIPTION

Doors and windows are typically hung in a frame which supports the door or window, and permits a range of movement. There are numerous components included in door and window systems. The components may have complex shapes that need to fit together precisely so that the door or window functions properly and creates a sealed barrier between inside and outside. Door and window system components have numerous faces oriented in different directions, each of which creates the possibility for bowing, twisting, cupping, crooking, shrinking, warping, etc. Bowing affects may be minimized, or at least resisted, by incorporating thin sheets of composite material, for example, phenolic paper, carbon composites, or other composites that a have a high degree of deflection resistance edge-to-edge on the flat plane of the composite. A strengthening sheet may be glued or integrated in a composite material to decrease or eliminate movement across the glued face of the composite and wood laminated connecting surfaces. Strengthening sheets may be incorporated in composites so as not to interfere with the aesthetics of the natural wood finish, while providing the desired stiffening properties. The approach of using a strengthening sheet such as phenolic paper may be applied in many different product configurations depending on the direction(s) of potential movement.

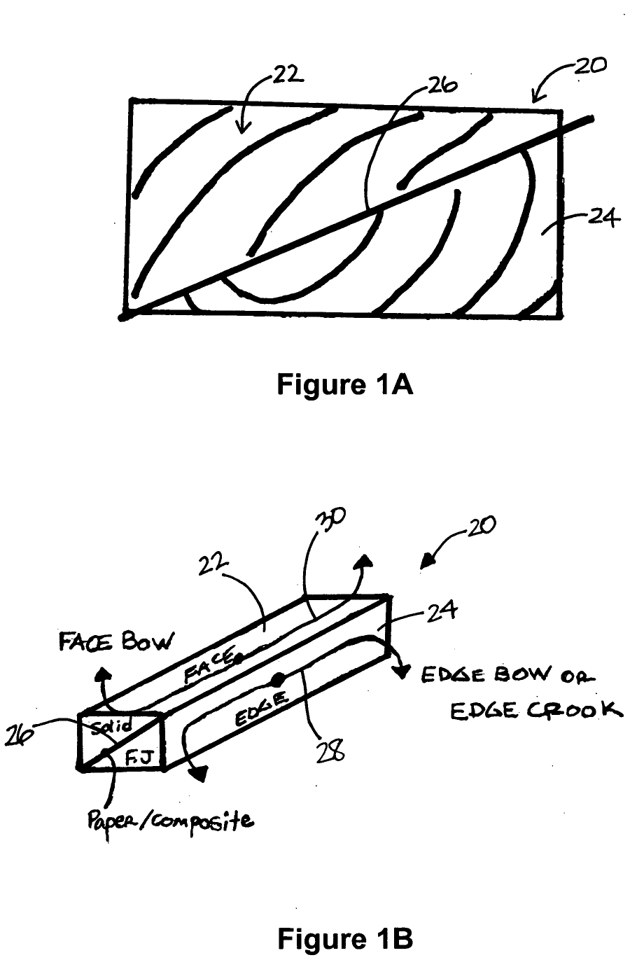

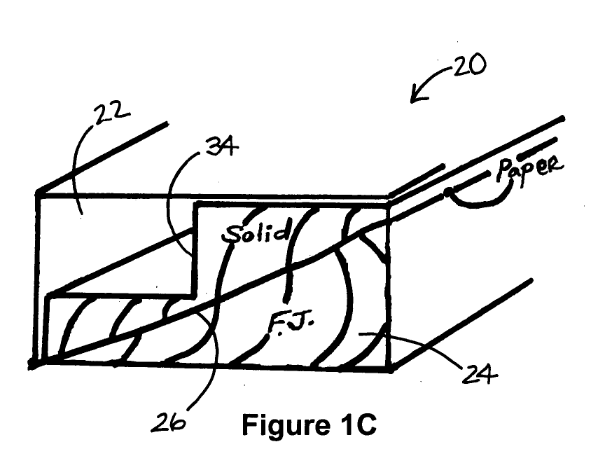

FIG. 1A shows a component referred to as an inside stop 20. Stop 20 may be attached to the frame of a casement type window or door jamb. Stop 20 includes solid wood component 22 for constructing the exposed area of stop 20 and finger jointed component 24 made of scrap wood for forming the non-exposed area of stop 20. Strengthening sheet 26, for example, phenolic paper, is glued in the interface between components 22 and 24.

As shown in FIG. 1B, stop 20 is susceptible to edge bow or crook affects. An edge bow may occur as indicated by arrow 28. A face bow may occur as indicated by arrow 30. A window sash may open or close against the inside stop. Consequently, “edge crook or edge bow” in the stop can cause an unsightly gap between the closed sash part and the stop. Edge crook/bow may be very difficult to straighten out and hold with a fastener such as a nail or screw. A face bow may not be as much of a problem because it may be controlled by putting a nail in the face of the stop which is the normal way the stop is fastened to the frame.

One face and one edge of the wood stop is seen on the inside of the window by a homeowner. It may be sold as a stain grade product, so that no composite material may show on the face. The other side of the stop is hidden and can be a lower grade material such as finger-jointed wood, MDF, OSB or plywood for example. Strengthening sheet 26 is placed diagonally the profiled stop so the aesthetics of the stained grade material is unaffected. By placing the composite at an angle offset slightly from opposing corners between components 22 and 24, bowing across any plane is resisted. The composite is hidden inside the component so that it is not seen after the component is installed. Test data shows an 85% reduction in edge bow/crook affect along the edge of the widest plane of the product. Other test data showed a 91% reduction in face bow affects which would be measured as deflection along the face of the widest plane. FIG. 1C shows component 20 as it is finally milled to form a stop or step shape in solid component 22.

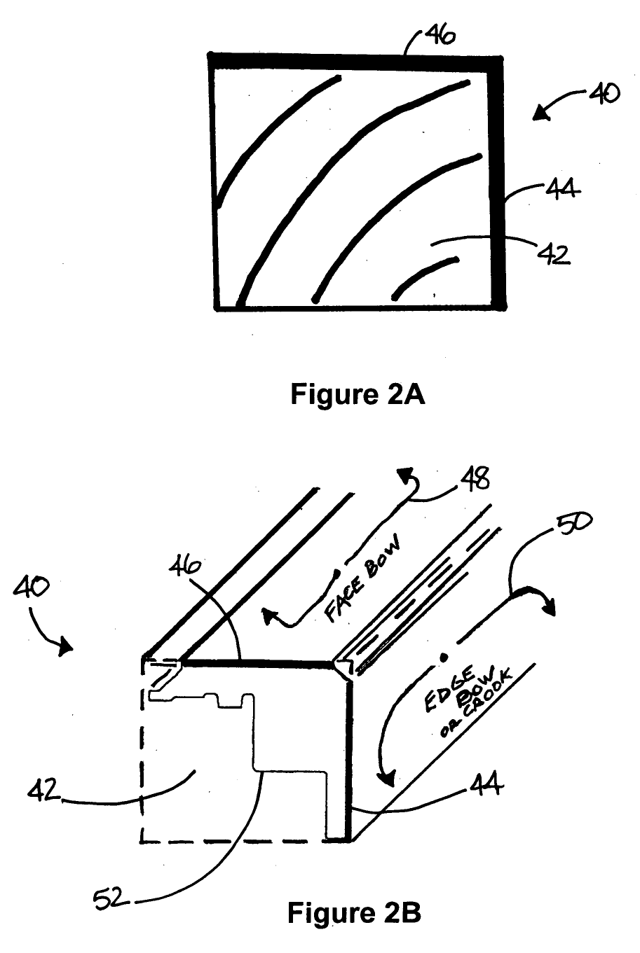

FIG. 2A shows a cross-section of a sash component from a double hung or sliding window product. Sash component 40 includes wood component 42 and strengthening sheets 44 and 46 applied or glued to wood component 44 at a right angle. Strengthening sheets 44 and 46, for example, may be sheets of phenolic paper. FIG. 2B shows potential face bow and edge bow affects, indicated by arrows 48 and 50 respectively. Face bow affects are resisted by strengthening sheet 44, while edge bow affects are resisted by strengthening sheet 46. FIG. 2B also shows the final profile 52 of sash component 40. Typically, a window has two sashes that meet together in the middle of the window. A double-hung assembled sash moves up and down. A sliding sash moves side-to-side. The sash component shown in FIGS. 2A and 2B is the type of sash that connects in the middle of the window. The difficulty with this component is that any face bow or any edge bow can cause significant problems with the movement and connection in the middle of the sash. The design of the component does not lend itself to the cost effective solution of using a diagonal strengthening sheet, for example, as illustrated in FIGS. 1A-C. Therefore, the design is modified to put phenolic papers in perpendicular or 90° angles to each other, to control face and edge bowing.

Phenolic paper has very little strength or stiffness as you bend the thin face. However, when bending the sheet along an edge, it is very stiff and strong. Accordingly, by opposing the faces of the phenolic papers they act cooperatively to create bi-polar or multi-directional resistance to movement.

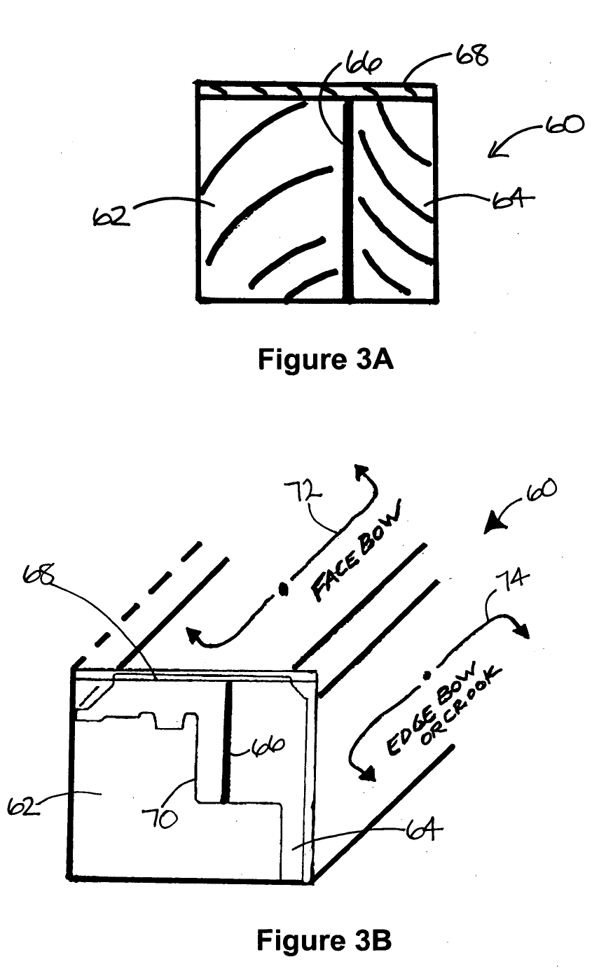

FIGS. 3A and 3B show a sash component with exposed visible faces which preclude the design option shown in FIGS. 2A-B. Sash component 60 includes finger-jointed component 62 connected to solid wood component 64 via strengthening sheet 66 at the internal interface. Veneer sheet 68 is attached to a visible side of sash component 60. FIG. 3B shows final milled profile 70 of sash component 60. Strengthening sheet 66 resists face bowing in the direction indicated by arrow 72. However, unlike the design in FIGS. 2A-B, sash 60 has no strengthening sheet that resists edge bow affects in the direction indicated by arrow 74.

In the sash component shown in FIGS. 3A-B, it is not possible to get the bi-polar stiffness of perpendicular strengthening sheets as shown in FIGS. 2A-B because the paper or composite would appear in an exposed area of the sash. A single sheet of phenolic paper is used which provides stiffness in one direction for this particular item.

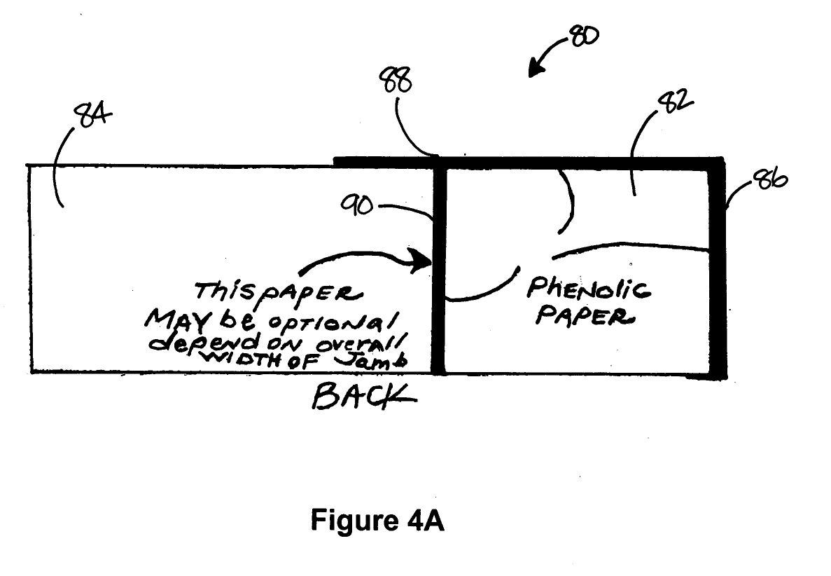

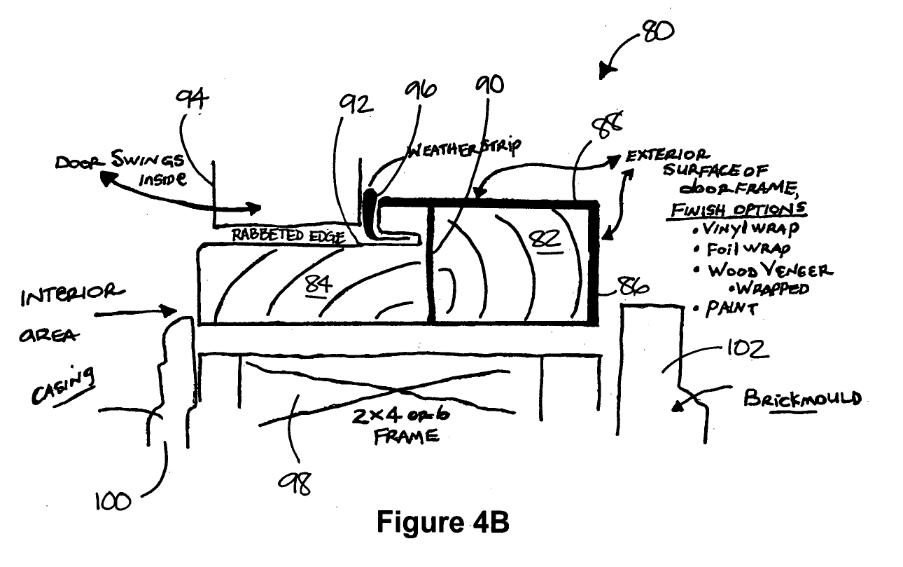

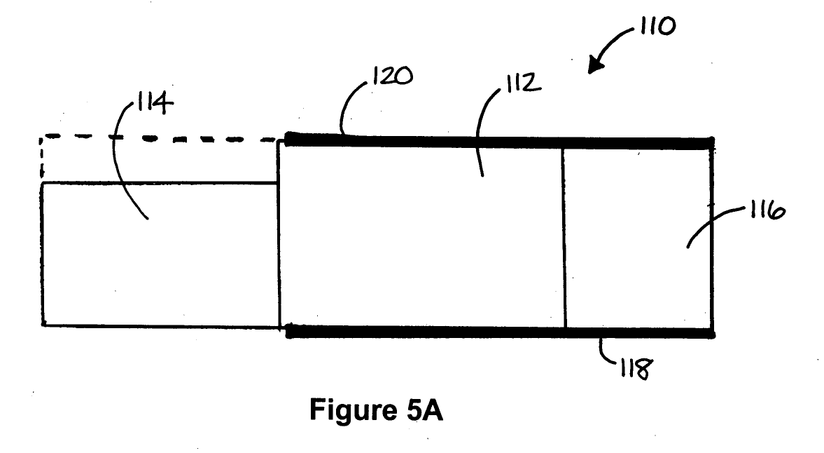

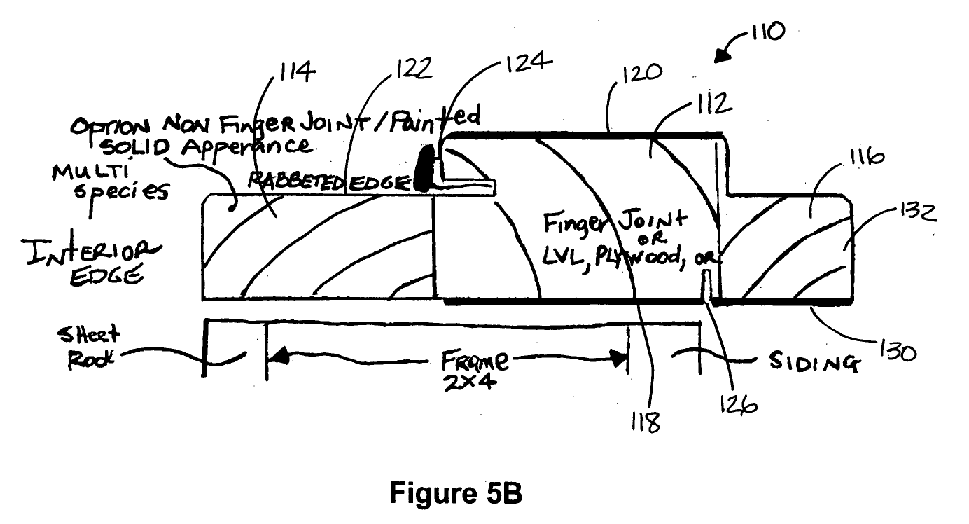

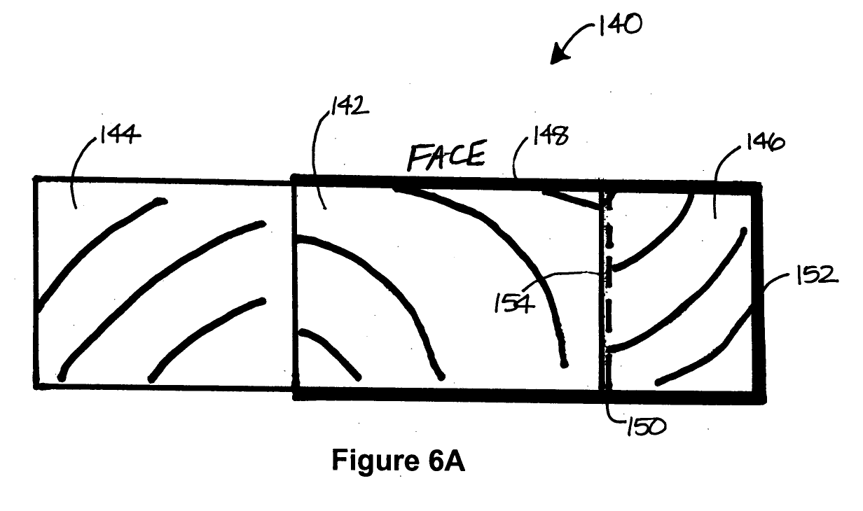

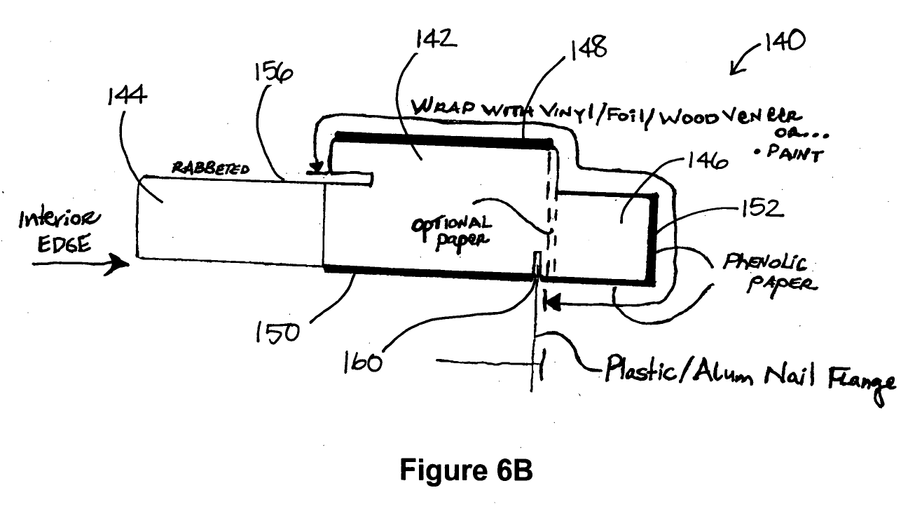

FIGS. 4-6 show various door frame designs. In this series of figures, two types of exterior door frames are shown for supporting a door that swings into a building. FIGS. 4A-B show a door frame design that uses a brick mould exterior trim. In FIGS. 5A-B and FIGS. 6A-B, the brick mould is eliminated and replaced with an extension typically referred to as an “exterior jamb nosing”. Next, a plastic or aluminum nailing flange is installed in the groove on the back side of the jamb to attach and flash the door frame. This type of door frame design is common with an aluminum or vinyl clad door frame. The reinforcement configurations shown in FIGS. 4-6 may also be applied to a sliding door jamb in contrast to a swinging door jamb. A sliding door frame would require a different profile for the jamb. Straightness and strength are primary requirements of door frames because they connect the door to the building structure. One of the biggest bowing issues in a door frame is the face bow. If the frame bows toward the door, it may pinch against the door making it difficult to open and close the door or sash. Likewise, if it bows away from the door, it may create a gap. causing air leakage.

Another market-driven issue is the overall strength of the door frame, especially with respect to wind load building codes especially in hurricane regions. Highly restrictive codes exist and are being incorporated in such places as Dade County, Florida and much of the East Coast. Buildings are required to have very high impact ratings for doors and windows, especially in hurricane-prone areas. The strength of the frame, as well as the window, stop shown in FIGS. 1A-C, are a critical component when measuring the overall window or door's ability to meet the impact requirements. Drawings 4-6 provide designs that achieve benefits of increased strength and stiffness, in addition to bowing resistance.

FIG. 4A shows door jamb component 80 including hidden component 82 and exposed component 84. Hidden component 82 may be a lower quality composite such as finger-jointed stock, MDF, OSB, or plywood, etc. Exposed portion 84 may be solid wood or may be lesser quality material that will eventually be painted. Strengthening sheets 86 and 88 are provided at a right angle configuration, as shown. Strengthening sheet 90 is optionally provided at the interface between hidden component 82 and exposed component 84. FIG. 4B shows end 80 after further processing and installation in a wall. Rabbeted edge 92 is cut into exposed component 84 to accommodate door 94. Weather strip 96 is provided to seal the gap between door 94 and jamb component 80. Strengthening sheets 86 and 88 are ultimately hidden by finishing material such as a vinyl wrap, a foil wrap or a wood veneer wrap. Building frame 98 has casing 100 on an interior side and brick mould 102 on an exterior side to finish the jamb installation.

The design shown in FIGS. 4A-B is similar to the bi-polar perpendicular paper/composite construction discussed in FIGS. 2A-B. The phenolic paper across the exterior face plane of the door jamb provides a stiffness, and also a hard face that can be painted or wrapped with a vinyl or foil film for a hard, low-maintenance finished surface. A wood appearance may also be achieved by applying a wood veneer over the phenolic papers. Then on a 90° plane phenolic paper is applied one or two other locations to work against the other horizontal face papers to provide bow resistance in all four directions. The internal phenolic papers can be incorporated internally or on an outer edge of the jamb if paint will eventually be applied to the exterior edge. Phenolic paper provides a smooth hard painted, vinyl or foil-wrapped surface. If a customer wants a stained grade wood finish, then a wood edge may be bonded over the phenolic paper.

FIGS. 5A-B show another jamb design. In this case, two strengthening sheets are applied in parallel. As shown in FIG. 5A, jamb component 110 includes hidden component 112 and exposed component 114. Hidden component 112 may be finger-jointed stock or LVL, plywood, etc. Exposed component 114 may be solid wood. Alternatively, exposed component 114 may be lesser quality stock if it will eventually be painted. External component 116 should be solid wood to improve impact toughness or maybe another appropriate material. Strengthening sheets 118 and 120 are applied in parallel planes on front and rear faces, respectively of jamb component 110.

FIG. 5B shows jamb 100 after further processing and installation in a wall. Rabbeted edge 122 is cut to accommodate a door. Weather stripping 124 is provided to seal the gap between the door and the stop. Another rabbet cut is made on the external side of the jamb. Slot 126 provided on the backside of jamb component 110 for receiving a plastic or aluminum nail flange.

In some instances, a bowing affect may be caused rather than inhibited when two strengthening sheets are used on opposing parallel surfaces if the sheets are not approximately the same size. This may be caused by moisture penetrating one of the faces more or less than the other. Another issue may relate to the fact that the phenolic paper shrinks and grows with heat and cold. If the two papers on opposing parallel faces are not close to the same dimensions then bowing or cupping may occur. Cupping occurs when the lineal edges of the part curl up or down. This may be partially controlled by putting a vertical paper in the construction that is perpendicular to horizontal paper. However, cupping may still occur. Edge cupping may or may not be a significant functional problem depending on where the cupping occurs.

As shown in FIG. 5B, the interior rabbeted edge of jamb component 110 may need to retain a wood appearance so that it can be stained to match the interior trim. On the opposite face, which is the back side of the jamb, there is a full width flat surface with no rabbeted profile cuts so that it is easier to laminate a strengthening sheet across the entire back side of the jamb. However, the problem of not balancing pieces with strengthening sheets of equal size may cause the wood to move either cupping or bowing. The rabbeted area where the door closes and is latched to the door frame is crucial for functioning of the door. If the rabbeted portion curls, cups or bows, this may cause the frame to pinch against the edge of the door and cause performance issues, and also may make it difficult to open or close the door. Accordingly, in the design shown in FIG. 5A, strengthening sheets 118 and 120 have substantially equal widths or areas.

Depending on the door frame design, it is sometimes desirable to make an additional rabbeted cut opposite the rabbeted cut that the door closes against. However, any cupping that may occur on this rabbeted cut is not as significant of a performance issue because no door closes against it. Accordingly, as shown in FIG. 5B strengthening sheet 130 may be applied on the back side of external rabbeted portion 132. One benefit to having the wider paper on the back side of jamb component 110 is that it will extend to the outside edge of the door jamb and may provide a hard surface that is less likely to dent or to be damaged in this high traffic area. Also, if the door frame profile is wrapped with a moisture barrier like a vinyl or foil film, then the face opposite the paper will have a moisture barrier that will prevent moisture-induced bowing.

FIGS. 6A-B shows another example of a door jamb with reinforcing strengthening sheets. The jamb shown in FIGS. 6A-B is similar to the one described above and shown in FIGS. 5A-B, except there is an additional strengthening sheet, or two sheets, incorporated into the jamb at right angles to the other two strengthening sheets. Shown in FIG. 6A, jamb component 140 includes hidden component 142 which is connected to exposed component 144 and external portion 146. End component 142 may be made of finger jointed stock or some other lower quality wood composite material. Exposed component 144 may be made of solid wood if the grain will be exposed in the final product. Alternatively, exposed component 144 may be made of a lesser quality wood composite material if it is going to be painted. External portion 152 may be made of hard wood to improve impact toughness. Strengthening sheets, for example, phenolic paper 148, 152, and 150 are provided as shown. Optionally, another strengthening sheet 154 may be applied between end component 142 and external component 146. FIG. 6B shows jamb component 140 after further processing. Rabbeted face 156 is created to accommodate a door. External portion 146 may also be rabbeted as shown. A plastic or aluminum nail flange may be inserted in slot 160 at the backside of jamb component 140.

The jamb system shown in FIGS. 6A-B incorporates the perpendicular strengthening sheet design to provide increased stiffness, strength and stability in multiple directions. Additionally, having a phenolic paper on the outer edge of external portion 152 protects damage prone parts of the door frame. Optionally, phenolic paper may be applied in the center of the jamb across the full width.

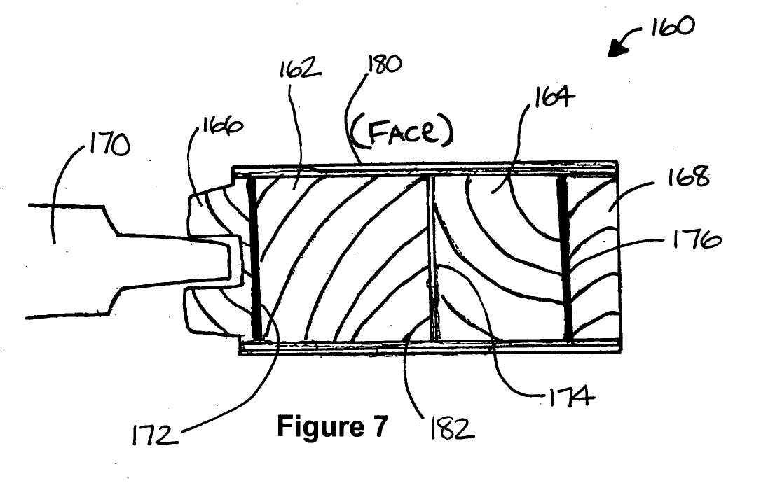

FIG. 7 shows a cross section of a stile or a rail for a door or window. Door or window component 160 includes internal portions 162 and 164 which may be made of finger jointed stock or other low grade wood composite material. End portions 166 and 168 will be exposed, and are therefore generally made of solid wood. If end portions 166 and 168 will eventually be painted, then they may be made of lower grade wood composite material. End portion 166 has a groove for receiving an edge of a wood panel or glass panel 170. Vertical strengthening sheets 172, 174, and 176 are incorporated into door or window component 160 in a perpendicular orientation to panel 170. Additional strengthening sheets 180 and 182 are applied in parallel planes perpendicular to the other strengthening sheets 172, 174, and 176. Finally, wood veneer sheets 180 and 182 may be applied to give the appearance of solid wood on the face and back side of stile or rail 160.

The door or window component 160, as shown in FIG. 7, uses a perpendicular phenolic paper configuration to provide a more stable door and window stile or rail for the fenestration industry. Phenolic paper also provides a moisture barrier that helps control moisture migrating into the wood substrate which may help to prevent face and/or edge bowing of the stile or rail in the door or window. Moisture barriers are also incorporated on each edge of the stile or rail, to stop moisture migration from the edge. In one example, two papers are used on the vertical edges. In other examples, additional vertical papers/composites are incorporated into the stile or rail, in combination with at least two horizontal papers to balance the moisture migration and strength and stiffness benefits.

The specific embodiments disclosed and illustrated herein should not be considered as limiting the scope of the invention, as understood by a person having ordinary skill in the art. Numerous variations are possible within the scope of the appended claims. Subject matter of the invention includes all novel and non-obviousness combinations and subcombinations of the various elements, features, functions, and/or properties disclosed herein.

1. A structural component for framing a door or window comprising
An elongate wood composite member having a rectangular cross-section including a solid wood component and a low-grade wood component comprising at least one of the following materials: finger-jointed stock, MDF, OSB, LVL, and plywood; each of the solid wood and low-grade components having a substantially triangular cross-section, thereby defining a diagonal interface between the two components, and
a strengthening sheet material secured in the diagonal interface.

2. The structural component of claim 1 wherein the strengthening sheet material is phenolic paper.

3. The structural component of claim 2 wherein the strengthening sheet material spans substantially the entire diagonal interface,

4. The structural component of claim 1, wherein the strengthening sheet is glued in the diagonal interface.

5. The structural component of claim 1, wherein the composite member has first and second corners defining a diagonal plane substantially parallel to the diagonal interface, the first and second corners being formed in the solid wood component.

6. The structural component of claim 1, wherein the strengthening sheet comprises at least one of the following materials: phenolic paper, carbon composite, and other composite materials that have a high degree of deflection resistance edge-to-edge.

7. A structural component for framing a door or window comprising
An elongate wood composite member having a rectangular cross-section including a solid wood component and a low-grade wood component comprising at least one of the following materials: finger-jointed stock, MDF, OSB, LVL, and plywood; wherein the composite member has first and second corners defining a diagonal plane substantially parallel to a diagonal interface between the solid wood and low-grade wood components, and
a strengthening sheet material secured in the diagonal interface between the solid wood and low-grade components.

8. The structural component of claim 7, wherein the strengthening sheet comprises phenolic paper.

9. The structural component of claim 7, wherein the strengthening sheet spans substantially the entire diagonal interface between the solid wood and low-grade wood components.

10. The structural component of claim 7, wherein the solid wood component has a milled profile for use in a casement type window or door jamb.

11. The structural component of claim 10, wherein the milled profile includes a stop portion.

12. A sash component for a double hung or sliding window product comprising
an elongate wood member having a first side, and a second side perpendicular to the first side, a milled profile being configured opposite the first and-second sides for supporting a sheet of glass and stopping another window component, wherein each of the first and second sides is substantially covered by a strengthening sheet.

13. The sash component of claim 12, wherein the strengthening sheets comprise phenolic paper.

14. A sash component for a double hung or sliding window product comprising
an elongate wood member having a first side, and a second side perpendicular to the first side, a milled profile being configured opposite the first and second sides for supporting a sheet of glass and stopping another window component, wherein the wood component is formed of a solid wood portion and a low-grade wood portion,
a strengthening sheet interposed between the solid wood portion and the low-grade wood portion, the strengthening sheet being oriented substantially perpendicular to the first side of the wood member, and
a veneer sheet at least partially covering the first side of the wood member.

15. The sash component of claim 14, wherein the strengthening sheet comprises phenolic paper.

16. A jamb component for a window or door comprising
an elongate wood composite member having a back side and an exposed side, a stop portion having a stepped-up inner surface defined on the exposed side of the composite member, wherein the composite member has at least one low-grade wood portion forming at least most of the stepped-up inner surface, and
a first strengthening sheet adhered to the stepped-up inner surface of the composite member.

17. The jamb component of claim 16, wherein the low-grade wood portion has comprises at least one of the following materials: finger-jointed stock, MDF, OSB, LVL, and plywood.

18. The jamb component of claim 16, further comprising
a second strengthening sheet adhered to the backside of the composite member.

19. The jamb component of claim 18, wherein the first and second strengthening sheets have approximately equal areas.

20. The jamb component of claim 16, wherein the strengthening sheet comprises phenolic paper.

21. The jamb component of claim 16, further comprising
one or more additional strengthening sheets disposed perpendicular to the first strengthening sheet.

22. The jamb component of claim 18, further comprising
a third strengthening sheet disposed perpendicular to the first and second strengthening sheets.

23. A rail or stile for a window or door comprising
an elongate composite member having front and back faces, and end portions, one of the end portions including a groove for receiving an edge of a glass sheet or panel, the composite member including at least one internal portion made of low-grade wood material defining at least parts of the front and back faces of the member, and
first and second strengthening sheets substantially covering the front and back faces of the composite member.

24. The rail or stile of claim 23 wherein the strengthening sheets comprises phenolic paper.

25. The rail or stile of claim 23 further comprising
at least two additional strengthening sheets disposed perpendicular to the first and second strengthening sheets.
